(19) United States
(12) Patent Application Publication
(10) Pub. No.: US 2018/0174477 A1
(43) Pub. Date: Jun. 21, 2018

(54) POLLING TOOL FOR FORMATIVE ASSESSMENT

(71) Applicant: All In Learning, Inc., Denton, TX (US)

(72) Inventor: Francis W. Johnson, Collinsville, TX (US)

(21) Appl. No.: 15/381,640

(22) Filed: Dec. 16, 2016

(51) Int. Cl. G09B 7/10; G09B 5/02

(52) U.S. Cl. CPC G09B 7/10; G09B 5/02

(57) ABSTRACT

According to one embodiment, a method comprises receiving one or more images comprising at least one response device, each response device having an identifier identifying the response device and two or more response indicators. The method further comprises identifying, by the respective identifier, one or more response devices in the one or more images, and determining, for each identified response device, a response based on an absence of one or more response indicators of the response device in at least one of the one or more images.

### TECHNICAL FIELD

This disclosure relates in general to formative assessment, and more particularly, to formative assessment using a polling toll.

### BACKGROUND

The term “formative assessment” refers to assessment procedures that permit educators to gauge student comprehension of material and to modify teaching and/or learning activities to promote student comprehension. Some commons types of formative assessment include orally questioning students during a lesson or administering one or more quizzes. However, such common variations of formative assessment have drawbacks. For example, although questioning might gauge one student's understanding of the material being taught, that student's understanding might not be representative of the understanding of the entire class. As another example, evaluating student responses from quizzes takes away valuable teaching time that could be redirected to student attainment.

Because some of the more common variations of formative assessment are associated with drawbacks, tools have been developed in the recent years to gauge student attainment. As one example, U.S. Pat. No. 9,098,731 by Amy et al. (“Amy”) describes a polling platform operable to determine a student's response by determining an orientation of a response device. For example, the polling platform may determine that a student's response is “A” when the response device is in a first orientation and that the student's response is “B” when the response device is in a second orientation.

Although the polling method described in Amy may enable an educator to gauge student attainment, this method may be overly complicated and unforgiving. For example, because a student's response is tied to the orientation of the response device, a student must remember which orientation corresponds to each response (e.g., “A,” “B,” “C,” “D”). Remembering each orientation may be particularly troublesome for younger students (e.g., students between the ages of 5-12). Additionally, because each response is tied to a particular orientation, a student must be conscious of the way that (s)he is holding the response device. For example, the polling platform may not be able to determine a response for a student if the student's response device is held at an angle off of vertical. Thus, the polling method described in Kay may not accurately assess a student's comprehension of the material being taught because (1) the student may accidentally orient his/her response device in a manner that does not correspond to his/her answer; and/or (2) the polling platform could not decode a student response due to the particular orientation of the response device.

Associating an inaccurate response with a student may have certain effects. For example, an inaccurate assessment of a student response may have a negative impact on the student's grade in the particular class. As another example, an inaccurate assessment of student responses may indicate to an educator that the students are not understanding the material being taught. As a result, the educator may spend more time than necessary teaching certain material instead of moving on to teaching other material.

### SUMMARY OF THE DISCLOSURE

According to one embodiment, a method comprises receiving one or more images comprising at least one response device, each response device having an identifier identifying the response device and two or more response indicators. The method further comprises identifying, by the respective identifier, one or more response devices in the one or more images, and determining, for each identified response device, a response based on an absence of one or more response indicators of the response device in at least one of the one or more image.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram illustrating an example of a network environment for a polling tool for determining responses of one or more response devices;

FIG. 2 is a block diagram illustrating an example of two response devices that may be included in an image received by the polling tool of FIG. 1, according to certain embodiments;

FIG. 3 is an illustration of an environment for the response devices of FIG. 2;

FIG. 4 is a block diagram illustrating an example of the polling tool of FIG. 1, according to one embodiment;

FIG. 5 is a flow chart illustrating a method of determining a response of a response device using the polling of FIG. 4, according to one embodiment; and

FIG. 6 is a block diagram illustrating an example computer system that may be used to implement the method of FIG. 5, according to certain embodiments.

### DETAILED DESCRIPTION OF THE DISCLOSURE

The teachings of this disclosure recognize using a polling tool to quickly and accurately identify responses of response devices in an easy and inexpensive manner. The following describes systems and methods of identifying responses of response devices for providing these and other desired features.

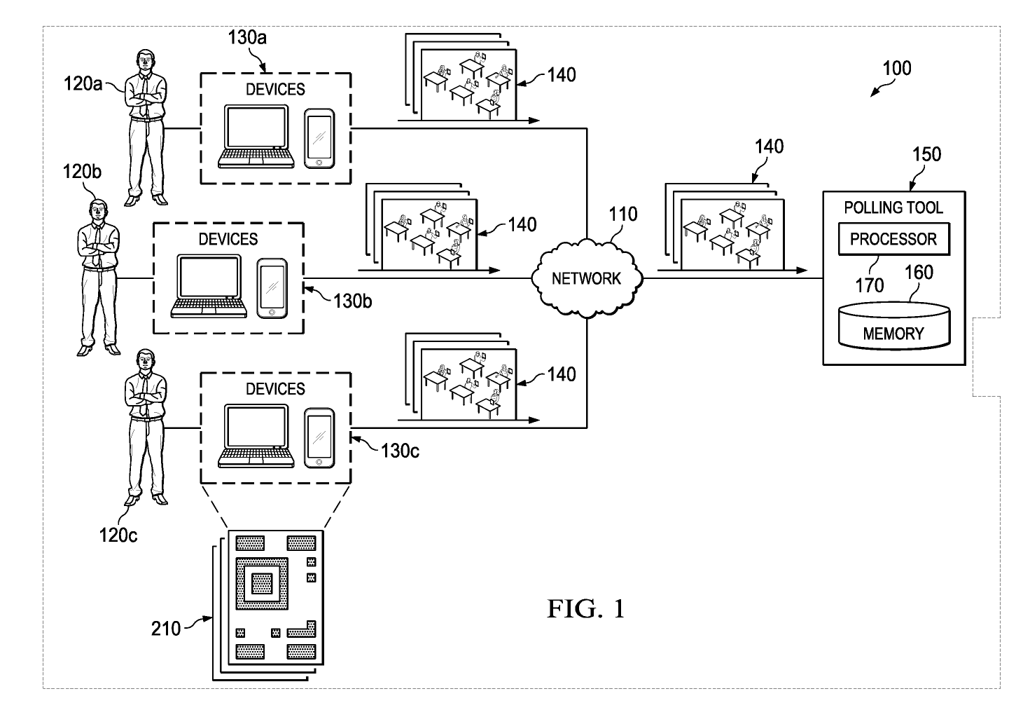

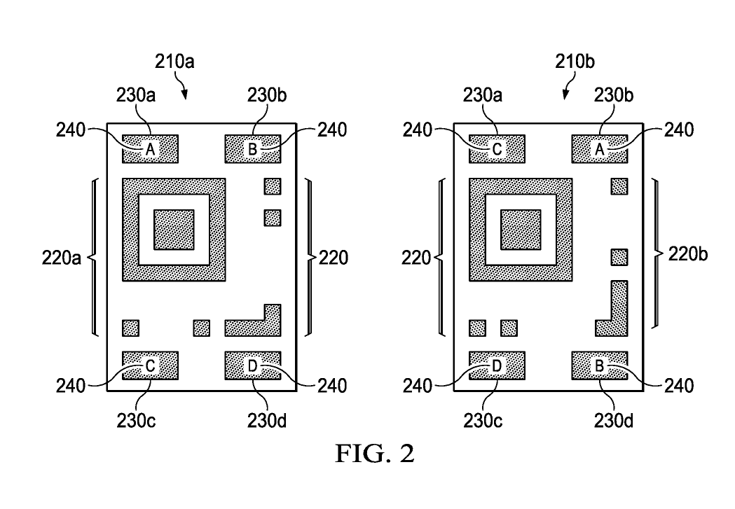

FIG. 1 illustrates a network environment for a polling tool. The network environment 100 may include a network 110, one or more users 120, one or more image capturing devices 130, and polling tool 150. In general, the teachings of this disclosure recognize using polling tool 150 to identify responses of response devices 210. As illustrated in FIG. 1, user 120 may capture one or more images 140 of response device 210 with an image capturing device 130 (e.g., response device 210 of FIG. 2) and send the one or more images 140 over network 110 to polling tool 150. In some embodiments, images 140 are individually captured photos. In other embodiments, images 140 are a stream of photos (e.g., a video). The polling tool 150 may analyze the received images 140 to determine a response of each response device 210 present in one or more of the received images.

Network 110 may refer to any interconnecting system capable of transmitting audio, video, signals, data, messages, or any combination of the preceding. Network 110 may include all or a portion of a public switched telephone network, a public or private data network, a local area network (LAN), an ad hoc network, a personal area network (PAN), a metropolitan area network (MAN), a wide area network (WAN), a local, regional, or global communication or computer network such as the Internet, an enterprise intranet, or any other suitable communication link, including combinations thereof. One or more portions of one or more of these networks may be wired or wireless. Examples of wireless networks 110 may include a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these.

Network environment 100 may include one or more users 120 in some embodiments. As depicted in FIG. 1, network environment 100 includes three users 120a-c. Although this disclosure describes and depicts only three users, this disclosure recognizes that network environment 100 may include any suitable number of users 120. Users 120a-c may be educators such as teachers and professors. In some embodiments, user 120 takes and sends images 140 using image capturing device 130. As used herein, the word “image” will be used interchangeably with the word “picture.” For example, an educator may take a picture 140 of his/her students with their respective response devices (e.g., response device 210) using image capturing device 130 and send the picture 140 over network 110 to polling tool 150.

A user 120 may be associated with one or more image capturing devices 130. As depicted in FIG. 1, each user 120 is associated with two image capturing devices 130. In some embodiments, image capturing devices 130 are configured to send and receive data from polling tool 130. In other embodiments, polling tool 130 is an application or program installed on image capturing device 130. In a preferred embodiment, image capturing device 130 is operable to take images 140 (e.g., with an onboard camera) and send, or otherwise make available, the images 140 to polling tool 150. Thus, this disclosure contemplates image capturing device 130 may be any appropriate device that can communicate over network 110. For example, image capturing device 130 may be a computer, a laptop, a wireless or cellular telephone, an electronic notebook, a personal digital assistant, a tablet, a server, a mainframe, or any other device capable of receiving, processing, storing, and/or communicating information with other components of network environment 100. Image capturing device 130 may also include a user interface, such as a display, a microphone, keypad, a camera or other appropriate terminal equipment usable by a user. In some embodiments, an application or program executed by image capturing device 130 may perform the image capturing functions described herein. Although this disclosure describes and depicts a single image capturing device 130 both capturing and sending the images, this disclosure recognizes that these functions may be performed by more than one image capturing device 130. For example, user 120 may take a picture using a standalone camera and transfer the picture to an image capturing device 130 capable making the picture available to polling tool 150.

Finally, network environment 100 may include polling tool 150. In some embodiments, such as depicted in FIG. 1, polling tool 150 may be a specialized computer comprising hardware such as a memory 160 and a processor 170. In other embodiments, polling tool 150 may be software configured to be executed on a processor of a computer such as image capturing device 130 of FIG. 1 and/or computer 600 of FIG. 6. In such an embodiment, polling tool 150 may use the memory and processing power of user device 130 and/or computer 600 to execute some or all logic disclosed herein. For example, a user 120 may take one or more images 140 using image capturing device 130 and run polling tool 150 on image capturing device 130 to process and analyze the images 140. After analyzing images 140, polling tool 150 may send the results (answers corresponding to each response device 210) to a server. In yet other embodiments, polling tool 150 may be a combination of software and hardware. This disclosure recognizes that the software may be hardware-specific (e.g., software may be specifically written for a Windows, Android, and/or iOS device).

Memory 160 of polling tool 150 is configured to store information about response devices 210 in some embodiments. For example, in some embodiments, memory 160 is configured to store an identifier 220 and a configuration of response indicators 230 for each response device 210. As will be described in more detail below in reference to FIG. 2, an identifier 220 may identify a particular response device 210 and each response indicator 230 of a response device 210 may correspond to a particular response.

Memory 160 is also configured to store a user identifier associated with a particular response device in some embodiments. For example, a student (e.g., student 320a), Name #1, may use response device 210a to indicate his/her responses to a question. In such example, memory 160 may be configured to associate Name #1 with the responses of response device 210a. Thus, polling tool 150 may be able to send notifications about particular students (e.g., “Name #1 has not yet answered” and/or “Name #1 answered ‘A’) to an image capturing device 130 in some embodiments. Polling tool 150 may send notifications through reporting module 450 to one or more image capturing devices 130 associated with the user 120 who sent the image 140 to polling tool 150.

In one example, memory 160 may store the following information comprised in TABLE 1:

Memory 160 is communicably coupled to processor 170 and processor 170 uses information stored in memory 160 to determine a response for a response device 210 in some embodiments.

Although FIG. 1 depicts polling tool 150 as a separate component than image capturing device 130, polling tool 150 may, in some embodiments, be software configured to be run on image capturing device 130. Thus, in some embodiments, image capturing device 130 may capture one or more images 140 which may be accessed and used by polling tool 150. Polling tool 150 may use processor power and memory of image capturing device 130 to analyze one or more images 140 and determine responses for each response device 210 in image(s) 140. In some embodiments, the results (responses) may be communicated, over network 110, from polling tool 150 to a server in network environment 100.

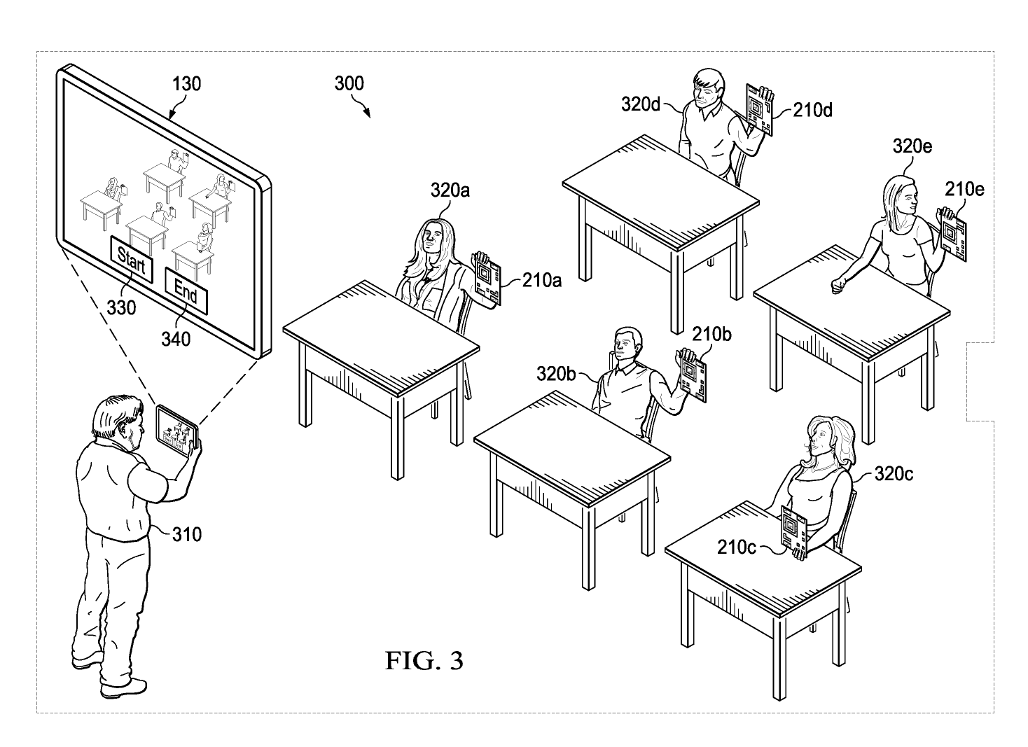

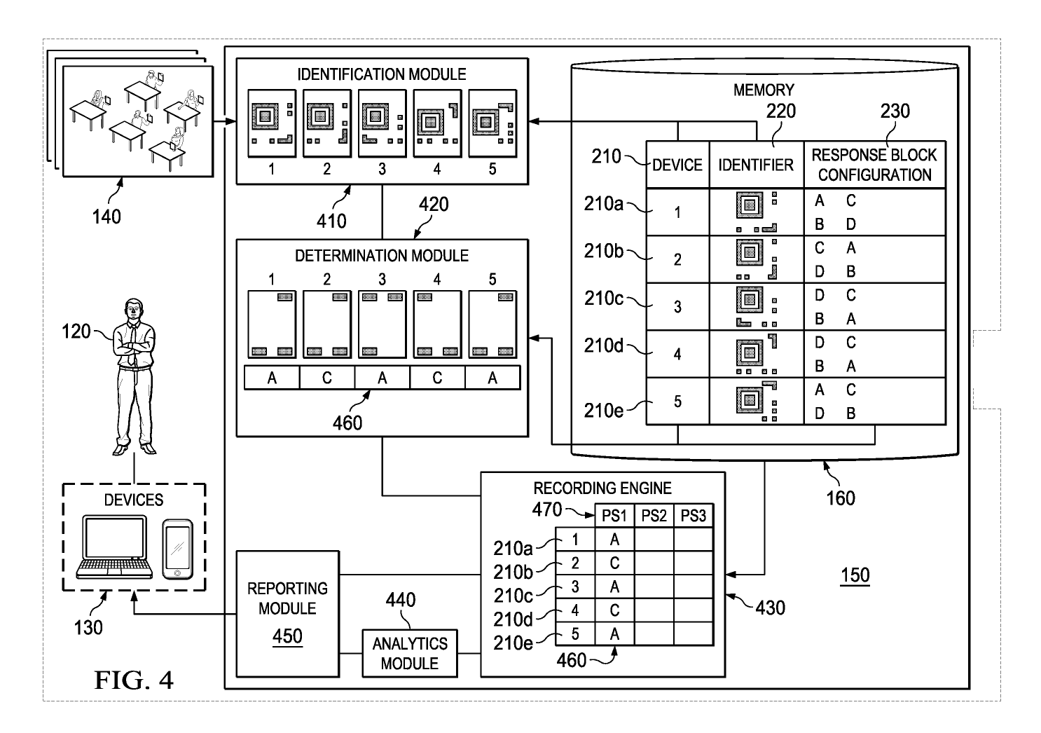

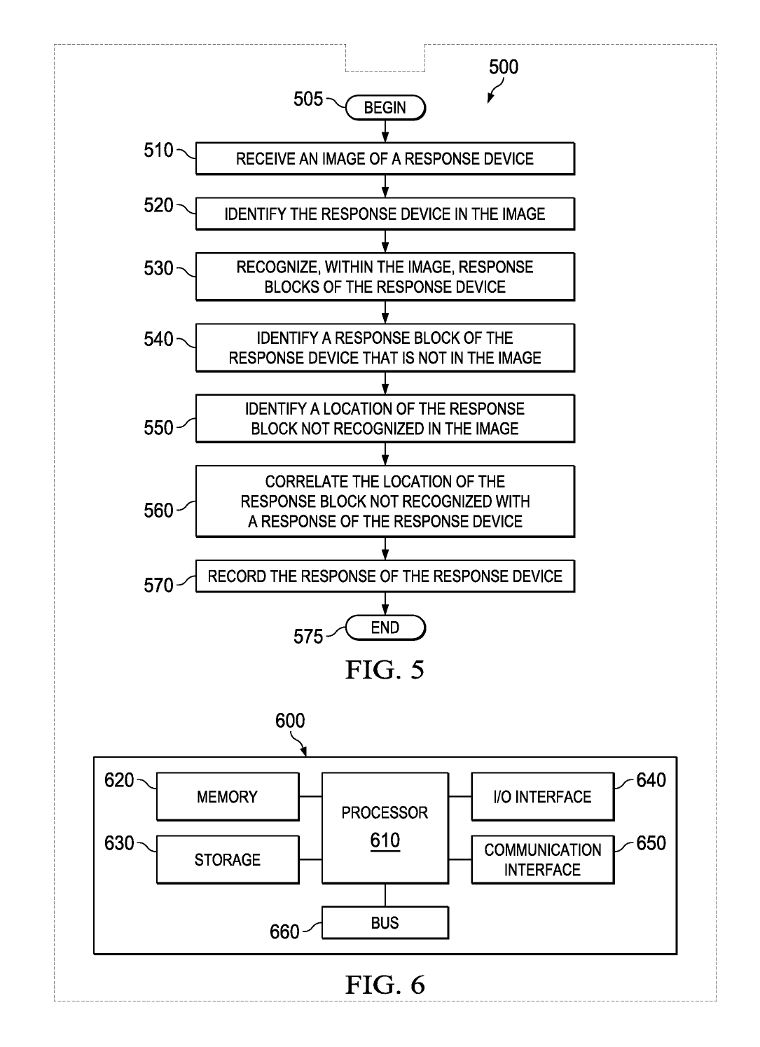

Generally, polling tool 150 is configured to receive one or more images 140 comprising one or more response devices 210 and determine a response of the one or more response devices 210. FIG. 2 illustrates one embodiment of the response devices 210 and FIG. 3 illustrates an example of an environment for response devices 210. FIG. 4 illustrates one embodiment of polling tool 150 and FIG. 5 illustrates a method of determining a response of a response device 210 using polling tool 150. Finally, a computer system operable to run polling tool 150 is illustrated and described in reference to FIG. 6.

FIG. 2 illustrates one embodiment of a response device 210. Two response devices 210a and 210b are depicted in FIG. 2 to emphasize possible differences between response devices 210. Each response device 210 includes an identifier 220 and response indicators 230 (e.g., 230a-d). As described above, identifier 220 may be configured to identify a particular response device 210. As such, each identifier 220 may correspond to a particular response device 210. As illustrated in FIG. 2, identifier 220a of response device 210a is different than identifier 220b of response device 210b. Identifier 220 may include a series of shapes of different sizes (e.g., one large square, four smaller squares, and an L-shaped polygon). Although this disclosure depicts a specific type of identifier 220, this disclosure recognizes that identifier 220 may be any suitable indicator capable of distinguishing one response device 210 from another. For example, identifiers 220 may be any combination of any number of shapes and sizes. As another example, identifiers 220 may be include one or more letters or one or more numbers.

Response device 210 may also include response indicators. As depicted in FIGS. 1-4, response indicators are depicted as response blocks 230. Although this disclosure describes and depicts a response indicator as a response block, this disclosure recognizes that a response indicator may be any suitable indicator (e.g., an image or shape) that permits a response to be indicated. As illustrated in FIG. 2, devices 210a and 210b include four response blocks 230 each, wherein each response block is located in a corner of device 210. Although this disclosure depicts response devices 210 comprising four response blocks 230, this disclosure recognizes that response devices 210 may include any suitable number of response blocks 230 that may be positioned at any suitable position on response device 210. For example, in some embodiments, a response device 210 may include only two response blocks (e.g., one response block 230 indicating “TRUE,” and the other response block 230 indicating “FALSE”) located along an edge of response device 210. As another example, a response device 210 may include eight response blocks 230, each response block 230 corresponding to a musical note (e.g., A, B, C, C♯, C♭, D, E, F), such that a user could play a song by covering response blocks 230 in succession. As described above, each response block 230 may correspond to a particular response (e.g., response block 230a may corresponds to response “A”). In some embodiments, a response may be a combination of response blocks 230. For example, a user of response device 210a may cover (e.g., with his/her hands) two response blocks (e.g., response blocks 230a and 230b) to indicate his/her response “AB”.

Response device 210 may have a particular configuration of response blocks 230. For example, as depicted in FIG. 2, response device 210a has a first configuration of response blocks 230 (e.g., top left corner indicates response “A,” top right corner indicates response “B,” bottom left corner indicates response “C”, and bottom right corner indicates response “D”) and response device 210b has a second configuration of response blocks 230 (e.g., top right corner indicates response “B,” top right corner indicates response “A,” bottom left corner indicates response “D,” and bottom right corner indicates “C”). A third response device 210 may have a different configuration of response blocks 230 (e.g., top left corner is “D,” top right corner is “C,” bottom left corner is “B”, and bottom right corner is “A”) or share a configuration of response blocks 230 with one or more other response devices 210 (e.g., response device 210a or 210b). This disclosure recognizes various benefits of randomizing the configuration of response blocks 230 on response devices 210. For example, randomizing the configuration of response blocks 230 may discourage students 320 from copying other students' responses, thereby encouraging each student 320 to respond to the best of his/her ability. As a result, educator 310 may more accurately gauge student attainment of material whilst also deterring students from attempting to game the system. Response devices 210 will be explained in more detail below in reference to FIG. 3.

In some embodiments, such as depicted in FIG. 2, each response block 230 includes a response identification 240. Response identification 240 may be an identification of a response block's corresponding response. For example, a small “A” indicating the response associated with response block 230a of response device 210a may be printed inside response block 230a. Response identification 240 may be any suitable size. Preferably, response identification 240 is a size legible by user of response device 210 but not legible by users of other response devices 210. In such an embodiment, a user of response device 210 does not have to memorize the location of each response block 230 corresponding to a particular response. Such an embodiment may be useful for younger students (e.g., children between the ages of 5-12).

Because an identifier and a configuration of response blocks 230 for each response device 210 is stored in memory 160, polling tool 150 may be able to determine a response of a response device 210. For example, processor 170 of polling tool 150 receives an image 140 of response device 210a in which the user of response device 210a is covering response block 230a (e.g., response block in top left corner of response device 210a) indicating response “A”. In such a scenario, processor 170 may query memory 160 for a configuration of response blocks 230 corresponding to the identifier 220a of response device 210a. After receiving the configuration of response blocks 230 for response device 210a, processor 170 may compare the configuration of response blocks 230 to the response blocks 230 presented in the image 140 and identify one or more response block(S) 230 not presented in the image 140. Processor 170 may then correlate a response based on the response blocks not presented in the image 140. For example, processor may determine that response block 230a (the response block not present in image 140) corresponds to response “A” and record “A” as the response for response device 210a.

Response device 210 may be configured to be inexpensively manufactured. Thus, in some embodiments, response device 210 is a piece of paper printed with indicia such as identifier 220 and response blocks 230. This disclosure recognizes that response device 210 may be used any number of times and therefore may be protected accordingly (e.g., sheet protector or laminate). In other embodiments, response device 210 may be a more permanent solution (e.g., plastic or wood board, tablet, etc.). Although this disclosure describes certain forms of response device 210, this disclosure recognizes that response device 210 may take any suitable form.

FIG. 3 illustrates an example of an environment 300 for response devices 210. As depicted, environment 300 is a classroom setting including an educator 310, an image capturing device 130, students 320, and a response device 210 for each student 320. As depicted in FIG. 3, student 320a is associated with response device 210a, student 320b is associated with response device 210b, student 320c is associated with response device 210c, student 320d is associated with response device 210d, and student 320e is associated with response device 210e. In such an environment 300, educator 310 may pose one or more questions to students 320 (e.g., by displaying the question on a display) and students 320 may respond to the questions using their respective response devices 210. In some embodiments, educator 310 receives feedback about student attainment of material being taught by sending images 140 of response devices 210 to polling tool 150.

Each student 320 may respond to a question posed by educator 310 by covering one or more response blocks 230 of his/her respective response device 210. For example, educator 310 may pose a multiple choice question to students 320 to which possible responses (or “answer choices) include “A,” “B,” “C,” and “D.” In such example, student 320a may indicate his response of “A” by covering response block 230a of response device 210a. In such example, response block 230a of response device 210a may correspond to answer choice “A,” response block 230b of response device 210a may correspond to answer choice “B,” response block 230c of response device 210a may correspond to answer choice “C,” and response block 230d of response device 210a may correspond to answer choice “D.” As another example, student 320b may indicate her response of “B” by covering response block 230a of response device 210b. The other students 230c-e may also indicate their responses by covering a response block 230 on their respective response devices 210c-e.

As described above, each response device 210 may have a particular configuration of response blocks 230. In some embodiments, each response device 210 may have the same configuration of response blocks 230. For example, each response device 210 may have a response block 230 corresponding to answer choice “A” in the top left corner of response device 210, have a response block 230 corresponding to answer choice “B” in the top right corner, have a response block 230 corresponding to answer choice “C” in the bottom left corner, and have a response block corresponding to answer choice “D” in the bottom right corner. In other embodiments, the configuration of response blocks 230 on each response device 210 may be different. For example, the response block indicating answer choice “A” (e.g., response block 230a) may be on the top left corner of response device 210a and the response block indicating answer choice “A” (e.g., response block 230b) may be on the top right corner of response device 210b.

In some embodiments, educator 310 takes one or more pictures 140 or a string of pictures 140 (e.g., a video) of the response devices 210 in environment 300 using image capturing device 130. For example, upon presenting a question to students 320, educator 310 captures one or more images 140 of one or more response devices 210 with image capturing device 130. In some embodiments, educator 310 uses a camera application on image capturing device 130 to take the one or more images and uses a different application on image capturing device 130 to forward the one or more images to polling tool 150.

In other embodiments, educator 310 runs a specialized program on image capturing device 130 having access to an onboard camera of image capturing device 130. The specialized program may be a corresponding program of polling tool 150 operable to be executed on image capturing device 130. The specialized program may be operable to do one or more of the following: access an onboard camera of image capturing device 130, automatically send images 140 from the image capturing device 130 to polling tool 150, and receive information from polling tool 150 (e.g., information about responses). For example, the specialized program may be configured to receive information about the responses of response devices 210 (e.g., 80% of received responses are “A,” 10% of responses are “B,” 5% of responses are “C,” and 5% of responses are “D”) and/or about responses devices 210 themselves (e.g., polling tool 150 has received responses from response devices 210a-c but has not received responses from response devices 210d or 210e). In embodiments without a corresponding program, image capturing device 130 may also be configured to receive information from polling tool 150. For example, image capturing device 130 may receive information about responses of response devices 210 and information about responses devices 210 via a text message or other notification method from polling tool 150.

The one or more images 140 may be captured by image capturing device 130 after initiating a polling session in some embodiments. Each polling session may correspond to a particular question of educator 310. For example, educator 310 may begin a polling session by selecting a “start” indication 330 on screen of image capturing device 130 and terminate a polling session by selecting a “end” indication 340 on the screen of image capturing device 130. Upon receiving a selection of the “start” indication 330, image capturing device 130 may begin capturing one or more images 140 until the polling session is terminated. As described above, the images 140 captured and sent by image capturing device 130 may include one or more response devices 210 indicating a response for student 320. The one or more images 140 for a polling session are sent to polling tool 150 to be analyzed and recorded. Upon initiating a second polling session, new images 140 are captured and sent to polling tool 150.

Polling tool 150 is configured to recognize changes in responses in some embodiments. For example, in a first image 140, student 320a may respond to a question by indicating answer choice “A.” Subsequently, student 320a may change his/her answer by indicating answer choice “B” and the response change is captured in a second image 140. Polling tool 150 may initially determine, based on the response blocks 120 visible from the first image 140, that student 320a's response is “A.” However, polling tool 150 may receive a second image 140 from image capturing device 130 and determine, based on the response blocks 230 visible from the second image 140, that student 320a's response is “B.” In some embodiments, polling tool 150 continues to analyze images 140, and responses in images 140, as the images 140 are received and accepts the last answer as student 320a's response. For example, student 320a may change his/her response any number of times during a polling session and polling tool 150 may determine that student 320a's response is the response received in the last image 140 prior to termination of the polling session.

FIG. 4 illustrates one embodiment of polling tool 150. In some embodiments, polling tool 150 comprises one or more modules. For example, as depicted in FIG. 4, polling tool 150 comprises an identification module 410, a determination module 420, a recording module 430, and a reporting module 440. The modules may be executed by a processor of polling tool 150 (e.g., processor 170 in FIG. 1). As depicted in FIG. 4, polling tool 150 also includes a memory 160 configured to store a plurality of identifiers 140 identifying a particular response device 210, and for each response device 210, a configuration of response blocks 230. Generally, identification module 410 is configured to receive an image from image capturing device 130 and identify each response device 210 in the image. Determination module 420 is configured to determine a response for each identified response device 210 and recording module 430 is configured to store the response for each identified response device 210. Reporting module 240 may also be configured to send information from polling tool 150 to one or more devices, including image capturing device 130.

As described above, polling tool 150 may include identification module 410. Identification module 410 may be configured to receive one or more images 140 from image capturing devices 130. Identification module 410 may be configured to identify each response device 210 in an image 140. For example, identification module 410 may be able to analyze each received image 140 and identify each response device 210 within the image. In some embodiments, identification module 410 identifies a response device 210 in an image by scanning the image for one or more identifiers 220. Thus, in some embodiments, identification module 420 receives identifiers 220 from memory 160 and scans the images for the received identifiers 220. An example algorithm for identification module 410 may be as follows: (1) receive (or retrieve) an image 140 taken by image capturing device 130; (2) receive a plurality of identifiers 220 from memory 160; (3) scan the received image 140 for each of the received identifiers 220; (4) in response to detecting an identifier 220 in the received image 140, identify a response device 210 corresponding to the detected identifier 220; and (5) send the image 140 and an identification of the response device 210 detected within the image 140 to determination module 420.

In some embodiments, identification module 410 is further configured to identify a time of receipt for each image 140. In such embodiments, identification module 410 can determine which image 140 was received later in time than another image 140. The timing information may be sent along with the corresponding image to determination module 420 to determine a response for a device 210.

Polling tool 150 may also include a determination module 420 in some embodiments. Determination module 420 may be configured to determine a response 460 for each response device 210 identified by identification module 420. To determine a response 460 of a response device 210, determination module 420 may analyze the one or more images 140 for edges of response blocks 230. As an example, determination module 420 may determine the presence of one or more response blocks 230 by identifying each edge of response block 230 and determine the absence of one or more response blocks 230 by not identifying one or more edges of a response block 230. In some embodiments, determination module 420 may run the following algorithm to determine a response 460 for a response device 210: (1) identify, based on an identification from identification module 420, a response device 210 in the received image; (2) query a database (e.g., memory 160) for a configuration of response blocks 230 corresponding to the response device 210; (3) compare the response blocks 230 of response device 210 presented in the image 140 to the stored configuration of response blocks 230 for the respective response device 210; (4) identify, within the image 140, the presence of three response blocks 230 and the absence of one response block 230; and (5) identify a response corresponding to the absent response block 230.

For example, image 140 may depict student 320a covering a response block 230a indicating response “A” on response device 210a. After identification module 420 identifies response device 210a in the image, determination module 420 may recognize response blocks 230b-d and not recognize response block 230a in the image 140. Determination module 420 may then identify a location of the unrecognized response block 230a (e.g., top left corner) and determine a response 460 corresponding to the location of the unrecognized response block 230a. In some embodiments, determining a response 460 corresponding to the location of an unrecognized block includes comparing the recognized and/or unrecognized response blocks 230 of a particular response device 210 to a stored configuration of response blocks 230 for the particular response device 210. Thus, taking the above example, determination module 420 may receive, from memory 160, a configuration of response blocks 230 for response device 210a identified by identifier 220 and determine a response 460 associated with the particular location of the absent response block. As depicted in FIG. 4, response block 230a corresponds to response “A.” Accordingly, determination module 420 determines that the response 460 of response device 210a is “A.”

As described above, determination module 420 may determine a response 460 for each response device 210 identified by identification module 410. For example, as depicted in FIG. 4, identification module 410 identified response devices 1-5 (e.g., response devices 210a-e) in image 140. Accordingly, determination module 420 determines responses for response devices 1-5. As illustrated in FIG. 4, determination module 420 determines the following responses 460 for response devices 210a-e, respectively: “A,” “C,” “A,” “C,” “A.”

In some embodiments, determination module 420 is also configured to update the response 460 of a response device 210. In some embodiments, an updated response may correspond to a student 320 changing his/her mind during a polling session. In some embodiments, determination module 420 determines a response 460 of a response device 210 for each image 140 it receives. In other embodiments, determination module 420 only determines a response 460 of a response device 210 in the last image 140 received from image capturing device 130 before termination of a polling session. Determination module 420 may be configured to determine which of the received images is the final image 140 (e.g., received latest in time) and determine a response 460 of response device 210 based on the final image 140. This may ensure that students 320 have the opportunity to change their response 460.

In some embodiments, such as depicted in FIG. 4, polling tool 150 also includes a recording module 430. In some embodiments, recording module 430 is configured to record a response 460 for a response device 210 for each polling session 470. Taking the above example, recording module 430 may be configured to record student 220a's response as “A.” In some embodiments, recording module 430 may be configured to update a recording. For example, in response to a determination by determination module 420 that response 460 of response device 210a has changed, recording module 430 may replace the response 460 recorded for response device 210a for the particular polling session 270. In some embodiments, recorded responses are stored in memory 160 and may be accessed at a later time by a user 120 of polling tool 150. For example, after teaching a lesson and asking questions to students 320 about the lesson, an educator (e.g., educator 310) may access information about recorded responses of students 320.

Polling tool 150 may also include an analytics module 440 in some embodiments. Analytics module 440 may be configured to perform various calculations using response information from response devices 210. The information used by analytics module 440 may be received from one or more other modules (e.g., identification module 410, determination module 420, recording module 430). For example, analytics module 440 may be configured to determine one or more percentages of response devices to respond with a particular response 460 (e.g., 60% of response devices 210 indicated response “A” and 40% of response devices 210 indicated response “C”). As another example, analytics module 440 may be configured to determine the number of response devices 210 that have responded during a polling session (e.g., 100% of response devices 210 have responded during a first polling session 270). Although specific types of analytics have been described, this disclosure recognizes that analytics module 440 may be configured to determine any suitable statistic regarding responses of response devices 210.

Polling tool 150 may also include a reporting module 450. In some embodiments, reporting module 450 sends information about one or more polling sessions 470 to a device. For example, in some embodiments, reporting module 450 sends information about a polling session to image capturing device 130. In some embodiments, image capturing device 130 may be the device used to capture and send images 140 of response devices 210. In other embodiments, reporting module 450 may send information about polling session 470 to a different image capturing device 130 associated with a user 120. Reporting module 450 may be configured to continuously update and send information about a polling session 470 in some embodiments. For example, reporting module 450 may send a notification to image capturing device 130 that polling tool 150 has not received a response 460 for response device 210c since the initiation of a polling session 470. As another example, reporting module 450 may send a notification to image capturing device 130 that polling tool 150 has received a response 460 for each response device 210. In other embodiments, reporting module 450 may send information about a polling session in response to an event (e.g., termination of a polling session). In some embodiments, reporting module 450 may send information about a response 460 of a response device 210 to image capturing device 130 and the information is presented on image capturing device 130. For example, in response to user selection of a response device 210 in an image (or on a screen of image capturing device 130), a response 460 for the response device 210 is displayed on the screen of image capturing device 130.

Although this disclosure describes and depicts polling tool 150 comprising certain modules that are configured to perform one or more functions, this disclosure recognizes that polling tool 150 may comprise any suitable module configured to perform any desired function. For example, one or more modules of polling tool 150 (e.g., identification module 410, determination module 420) may be configured to appropriately orient the response devices in images 140 so that polling tool 150 can identify identifiers 220 and/or determine responses 460 from response devices 210 in image 140. In some embodiments, determining whether the response device is appropriately oriented comprises identifying the configuration of identifier 220 on each response device 210. As an example, polling tool 150 may detect identifier 220 of response device 210a and determine whether the identifier 220, in its current orientation, matches any identifiers 220 stored in memory 160. If not, polling tool 150 may determine that the orientation is not an appropriate orientation and rotate identifier 220 until a corresponding identifier 220 is identified in memory 160. Upon detecting a corresponding identifier 220 in memory 160, polling tool 150 may determine (e.g., by identifying an original orientation of identifier 220 in image 140 and the rotated orientation of identifier 220) that response device should be rotated by a particular number of degrees in order to be in the appropriate orientation. In another embodiments, this is done by identifying a specific edge of response device 210 (e.g., top edge of response device 210) within image 140 and rotating the response device 210 until the specific edge is positioned correctly. In such an embodiment, polling tool 150 may determine a specific edge of response device 210 based on an amount of space between an object on response device 210 (e.g., identifier 220, response blocks 230) and the specific edge. In yet another embodiment, polling tool 150 identifies response device 210 within an image and compares it to response devices 210 stored in memory 160. In such an embodiment, the comparison may include rotating the response device 210 within image 140 up to 360° in order to determine the proper orientation for the response device 210.

In operation, polling tool 150 receives an image 140 from an image capturing device 130. The image 140 may comprise one or more response devices 210 indicating a response. After receiving image 140 from image capturing device 130, polling tool 150 identifies each response device 210 within image 140. In some embodiments, polling tool 150 identifies each response device 210 in image 140 by recognizing each occurrence of an identifier 220 stored in memory 160. Polling tool 150 may be able to distinguish response devices 210 from the noise (e.g., non-response devices) in the images 140. After identifying each response device 210 within image 140, polling tool 150 identifies a response 460 for each identified response device 210. In some embodiments, polling tool 150 identifies, within the received image 410, a response 460 for a response device 210 by identifying the presence or absence of response blocks 230 of response device 210. In some embodiments, a response block 230 of a response device 210 is absent from image 140 because a user of a response device 210 (e.g., student 320) is covering a response block 230 with his/her hand. Polling tool 150 then identifies the response that corresponds to the absent response block 230. In some embodiments, this is accomplished by identifying a location of an absent response block 230 and correlating the location of the absent response block 230 to a particular response. For example, educator 310 captures and sends an image to polling tool 150 that depicts student 320a covering a response block in the top left corner of response device 210a indicating answer “A.” Polling tool 150 identifies all response blocks 230 of response device 210a except for the response block 230 on the top left corner. Polling image capturing device 130 then determines that the response block 230 in the top left corner of device 210a corresponds to a response indicating “A” based on the response block configuration for response device 210a stored in memory 160.

FIG. 5 illustrates a method 500 of determining responses of response devices 210 using polling tool 150. The method 500 may begin at step 505 and continue to step 510. At step 510, polling tool 150 receives an image comprising a response device 210. In some embodiments, the identification module 410 of polling tool 150 receives the image. The image may be captured and sent, over network 110, by a user 120 using image capturing device 130. For simplicity, the method 500 is described in relation to determining a response for a single response device 210. Thus, the image received at step 510 includes only response device 210. However, it will be understood that the received image may include any number of response devices 210. As described above, each response device 210 may include an identifier 220 and response blocks 230. In some embodiments, the method 500 continues to step 510.

At step 520, polling tool 150 identifies response device 210 in the received image. In some embodiments, identifying response device 210 in the received image comprises identifying an occurrence of the identifier 220 corresponding to response device 210. Polling tool 150 may identify an occurrence of an identifier 220 by scanning the received image for an identifier 220 stored in memory 160. In some embodiments, polling tool 150 may receive a plurality of identifiers from memory 160 and scan the image for each identifier 220. The method 500 may continue to step 530 in some embodiments.

At step 530, polling tool 150 recognizes response blocks 230 of response device 210 within the image. Determination module 420 of polling tool 150 may perform this step in some embodiments. In some embodiments, polling tool 150 recognizes all but one response block 230 of response device 210. In other embodiments, polling tool 150 recognizes some but not all response blocks 230 of response device 210. Recognizing a response block 230 may comprise comparing the response device 210 in the image to the configuration of response blocks 230 for response device 210 stored in memory 160. In some embodiments, the method 500 continues to step 540.

At step 540, polling tool 150 identifies response blocks 230 of response device 210 that are not present in the received image. Determination module 420 of polling tool 150 may perform this step in some embodiments. In some embodiments, identifying that response blocks 230 are not present in the image comprises comparing the image of response device 210 to the configuration of response blocks 230 for response device 210 stored in memory 160. In some embodiments, the method 500 continues to step 550.

At step 550, polling tool 150 recognizes a location of the response block 230 not recognized in the received image. In some embodiments, this step is performed by determination module 420. As an example, polling tool 150 may determine that response block 230a of response device 210 is not presented in the received image, and subsequently, identify the location of response block 230a as the top left corner of response device 210. In some embodiments, the method 500 continues to step 560.

At step 560, polling tool 150 correlates the location of the response block 230 not recognized with a response of response device 210. Correlating a location of the absent response block 230 with a response permits polling tool 150 to determine a response for response device 210. In some embodiments, this step is performed by determination module 420 of polling tool 150. Correlating a location of the absent response block 230 with a response of response device 210 may comprise identifying a responses associated with the location of the absent response block(s) 230 and assigning the identified response to the response device 210. The response may be determined based on a configuration of response blocks 230 for response device 210 that is stored in memory 160. In some embodiments, after determining a response for response device 210, the method 500 may continue to a step 570.

At step 570, polling tool 150 may record the response for the response device 210. In some embodiments, the recording may be performed by recording module 430 of polling tool 150. Polling tool 150 may record the response for response device 210 in a database (e.g., memory 160 of polling tool 150). In some embodiments, the method 500 ends in a termination step 575.

In some embodiments, method 500 may include one or more steps. For example, method 500 may repeat steps 520-570 as many times as necessary to record a response for other response devices 210 in the received image. As another example, method 500 may include additional steps permitting polling tool 150 to change the recorded response for a response device 210 in response to receiving a subsequent image during the same polling session as the image received in step 510.

FIG. 6 illustrates an example of a computer system 600. As described above, polling tool 150 may be a program that is implemented by a processor of a computer system such as computer system 600. Computer system 600 may be any suitable computing system in any suitable physical form. In some embodiments, computer system 600 may be device 125. As example and not by way of limitation, computer system 600 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 600 may include one or more computer systems 600; be unitary or distributed; span multiple locations; span multiple machines; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

One or more computer systems 600, including user device 130, may perform one or more steps of one or more methods described or illustrated herein. As described above, user device 130 or another computer system 600 may perform all of the steps of the methods described herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As an example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

Computer system 600 may include a processor 610, memory 620, storage 630, an input/output (I/O) interface 640, a communication interface 650, and a bus 660 in some embodiments, such as depicted in FIG. 7. Although this disclosure describes and illustrates a particular computer system having a particular number of particular components in a particular arrangement, this disclosure contemplates any suitable computer system having any suitable number of any suitable components in any suitable arrangement.

Processor 610 includes hardware for executing instructions, such as those making up a computer program, in particular embodiments. For example, processor 610 may execute polling tool 150 to determines responses 460 of response devices 210. As an example and not by way of limitation, to execute instructions, processor 610 may retrieve (or fetch) the instructions from an internal register, an internal cache, memory 620, or storage 630; decode and execute them; and then write one or more results to an internal register, an internal cache, memory 620, or storage 630. In particular embodiments, processor 610 may include one or more internal caches for data, instructions, or addresses. This disclosure contemplates processor 610 including any suitable number of any suitable internal caches, where appropriate. As an example and not by way of limitation, processor 610 may include one or more instruction caches, one or more data caches, and one or more translation lookaside buffers (TLBs). Instructions in the instruction caches may be copies of instructions in memory 620 or storage 630, and the instruction caches may speed up retrieval of those instructions by processor 610. Data in the data caches may be copies of data in memory 620 or storage 630 for instructions executing at processor 610 to operate on; the results of previous instructions executed at processor 610 for access by subsequent instructions executing at processor 610 or for writing to memory 620 or storage 630; or other suitable data. The data caches may speed up read or write operations by processor 610. The TLBs may speed up virtual-address translation for processor 610. In particular embodiments, processor 610 may include one or more internal registers for data, instructions, or addresses. This disclosure contemplates processor 610 including any suitable number of any suitable internal registers, where appropriate. Where appropriate, processor 610 may include one or more arithmetic logic units (ALUs); be a multi-core processor; or include one or more processors 175. Although this disclosure describes and illustrates a particular processor, this disclosure contemplates any suitable processor.

Memory 620 may include main memory for storing instructions for processor 610 to execute or data for processor 610 to operate on. As an example and not by way of limitation, computer system 600 may load instructions from storage 630 or another source (such as, for example, another computer system 600) to memory 620. Processor 610 may then load the instructions from memory 620 to an internal register or internal cache. To execute the instructions, processor 610 may retrieve the instructions from the internal register or internal cache and decode them. During or after execution of the instructions, processor 610 may write one or more results (which may be intermediate or final results) to the internal register or internal cache. Processor 610 may then write one or more of those results to memory 620. In particular embodiments, processor 610 executes only instructions in one or more internal registers or internal caches or in memory 620 (as opposed to storage 630 or elsewhere) and operates only on data in one or more internal registers or internal caches or in memory 620 (as opposed to storage 630 or elsewhere). One or more memory buses (which may each include an address bus and a data bus) may couple processor 610 to memory 620. Bus 660 may include one or more memory buses, as described below. In particular embodiments, one or more memory management units (MMUs) reside between processor 610 and memory 620 and facilitate accesses to memory 620 requested by processor 610. In particular embodiments, memory 620 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 620 may include one or more memories 180, where appropriate. Although this disclosure describes and illustrates particular memory, this disclosure contemplates any suitable memory.

Storage 630 may include mass storage for data or instructions. As an example and not by way of limitation, storage 630 may include a hard disk drive (HDD), a floppy disk drive, flash memory, an optical disc, a magneto-optical disc, magnetic tape, or a Universal Serial Bus (USB) drive or a combination of two or more of these. Storage 630 may include removable or non-removable (or fixed) media, where appropriate. Storage 630 may be internal or external to computer system 600, where appropriate. In particular embodiments, storage 630 is non-volatile, solid-state memory. In particular embodiments, storage 630 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 630 taking any suitable physical form. Storage 630 may include one or more storage control units facilitating communication between processor 610 and storage 630, where appropriate. Where appropriate, storage 630 may include one or more storages 140. Although this disclosure describes and illustrates particular storage, this disclosure contemplates any suitable storage.

I/O interface 640 may include hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 640 may include one or more device or software drivers enabling processor 610 to drive one or more of these I/O devices. I/O interface 640 may include one or more I/O interfaces 185, where appropriate. Although this disclosure describes and illustrates a particular I/O interface, this disclosure contemplates any suitable I/O interface.

Communication interface 650 may include hardware, software, or both providing one or more interfaces for communication (such as, for example, packet-based communication) between computer system 600 and one or more other computer systems 600 or one or more networks (e.g., network 110). As an example and not by way of limitation, communication interface 650 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 650 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 650 for any of these networks, where appropriate. Communication interface 650 may include one or more communication interfaces 190, where appropriate. Although this disclosure describes and illustrates a particular communication interface, this disclosure contemplates any suitable communication interface.

Bus 660 may include hardware, software, or both coupling components of computer system 600 to each other. As an example and not by way of limitation, bus 660 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 660 may include one or more buses 212, where appropriate. Although this disclosure describes and illustrates a particular bus, this disclosure contemplates any suitable bus or interconnect.

The components of computer system 600 may be integrated or separated. In some embodiments, components of computer system 600 may each be housed within a single chassis. The operations of computer system 600 may be performed by more, fewer, or other components. Additionally, operations of computer system 600 may be performed using any suitable logic that may comprise software, hardware, other logic, or any suitable combination of the preceding.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Although this disclosure describes and depicts using response devices 210 to record responses 460 of students 320, this disclosure recognizes that response devices 210 may have other applications as well. For example, response devices 210 may be used to play or record music. In such an embodiment, each response block 230 on response device 210 may correspond to a particular note. For example, response block 230a may correspond to note “A,” response block 230b may correspond to note “B,” response block 230c may correspond to note “D,” and response block 230d may correspond to note “G”. In order to play a tune a user of response device 210 (e.g., student 320a) may cover and expose response blocks 210 in a particular order. For example, to play “Mary Had a Little Lamb” user may cover and expose response blocks 230 to play at least the following notes: B A G A B B B A A A B D D. As another example, response device 210 may be used as a controller. In such an embodiment, response blocks 230 may correspond to control buttons (e.g., play, stop, forward, and rewind) configured to control the operation of a program, a device, or any other suitable component capable of being controlled.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the embodiments described or illustrated herein that a person having ordinary skill in the art would comprehend. The scope of this disclosure is not limited to the embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A polling system comprising:
a plurality of response devices each having a respective identifier identifying the response device, each response device having at least four corners, each corner having a response indicator associated with a respective response, at least some of the plurality of response devices having response indicators associated with respective responses that are located at different locations on the response device than other ones of the response devices;
a camera operable to receive one or more images of one or more of the plurality of response devices;
a processor; and
a memory comprising logic executable by the processor to:
receive the one or more images;
identify, by the respective identifier, each of the one or more of the plurality of response devices in the one or more images;
determine, for each identified response device, a response for the response device by:
recognizing all but one of the response indicators on the response device and not recognizing one of the response indicators that corresponds to the response;
recognizing the location of the response indicator that is not recognized; and
correlating the location of the response indicator that is not recognized with a response for the response device.

2. A polling system comprising:
a plurality of response devices each having:
a respective identifier identifying the response device; and
two or more response indicators, each response indicator being associated with a respective response;
a camera operable to receive one or more images of one or more of the plurality of response devices;
a processor; and
a memory comprising logic executable by the processor to:
receive the one or more images;
identify, by the respective identifier, one or more of the plurality of response devices in the one or more images;
determine, for each identified response device, a response for the response device based on an absence of one or more response indicators of the response device in at least one of the one or more images.

3. The polling system of claim 2, wherein determining the response for the response device comprises:
identifying one or more of the response indicators on the response device and not identifying one or more response indicators of the response device that corresponds to the response;
recognizing, for each response indicator not identified, the location of the response indicator; and
correlating the location of the response indicators that are not identified with a response for the response device.

4. The polling system of claim 2, wherein the memory further comprises logic executable by the processor to:
identify a first response for a first response device based on a first image and a second response for the first device based on a second image, wherein the second image was taken later in time than the first image; and
determine that the second response is the response for the first response device.

5. The polling system of claim 3, wherein:
the memory is further configured to store a configuration of response indicators corresponding to each response device; and
correlating the location of the response indicators that are not identified comprises comparing the response device in the one or more images to the corresponding stored configuration for the response device.

6. The polling system of claim 2, wherein the response indicators of a second response device are arranged in a second configuration and the response indicators of a third response device are arranged in a third configuration.

7. The polling system of claim 2, wherein:
the memory further comprises logic executable by the processor to:
identify one or more response devices that are not recognized in the one or more images; and
send, over a network, a notification comprising an identification of the one or more response devices that are not recognized in the one or more images.

8. One or more computer-readable non-transitory storage media in one or more computing systems, the media embodying logic that is operable when executed to:
receive one or more images comprising at least one response device, each response device having an identifier identifying the response device and two or more response indicators;
identify, by the respective identifier, one or more response devices in the one or more images;
determine a response for each identified response device based on an absence of one or more response indicators of the response device in at least one of the one or more images.

9. The media of claim 8, wherein determining the response for the response device comprises:
identifying one or more of the response indicators on the response device and not identifying one or more response indicators of the response device that corresponds to the response;
recognizing, for each response indicator not identified, the location of the response indicators; and
correlating the location of the response indicators that are not identified with a response for the response device.

10. The media of claim 8, wherein the logic is further operable to:
identify a first response of a first response device based on a first image and a second response of the first device based on a second image, wherein the second image was taken later in time than the first image; and
determine that the second response is the response for the first response device.

11. The media of claim 9, wherein correlating the location of the response indicators that are not identified comprises comparing the response device in the one or more images to a corresponding stored configuration of response indicators for the response device.

12. The media of claim 8, wherein the response indicators of a second response device are arranged in a second configuration and the response indicators of a third response device are arranged in a third configuration.

13. The media of claim 8, wherein the logic is further operable to:
identify one or more response devices that are not recognized in the one or more images; and
send, over a network, a notification comprising an identification of the one or more response devices that are not recognized in the one or more images.

14. The media of claim 8, wherein the identifier comprises one or more shapes of one or more sizes.

15. A method comprising:
receiving one or more images comprising at least one response device, each response device having an identifier identifying the response device and two or more response indicators;
identifying, by the respective identifier, one or more response devices in the one or more images;
determining, for each identified response device, a response based on an absence of one or more response indicators of the response device in at least one of the one or more images.

16. The method of claim 15, wherein determining the response for each identified response device comprises:
identifying one or more response indicators on the response device and not identifying one or more response indicators of the response device that corresponds to the response;
recognizing, for each response indicators not identified, the location of the response indicator; and
correlating the location of the response indicators that are not identified with a response for the response device.

17. The method of claim 15, further comprising:
identifying a first response of a first response device based on a first image and a second response of the first device based on a second image, wherein the second image was taken later in time than the first image; and
determining that the second response is the response for the first response device.

18. The method of claim 16, wherein correlating the location of the response indicators that are not identified comprises comparing the response device in the one or more images to a corresponding stored configuration of response indicators for the response device.

19. The method of claim 15, wherein the response indicators of a second response device are arranged in a second configuration and the response indicators of a third response device are arranged in a third configuration.

20. The method of claim 15, further comprising:
identifying one or more response devices that are not recognized in the one or more images; and
sending, over a network, a notification comprising an identification of the one or more response devices that are not recognized in the one or more images.
